(19) United States
(12) Patent Application Publication
(10) Pub. No.: US 2010/0113084 A1
(43) Pub. Date: May 6, 2010

(54) POWER SAVING IN WIRELESS NETWORKS

(76) Inventor: Scott G. Kelly, Santa Clara, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/263,207

(22) Filed: Oct. 31, 2008

(51) Int. Cl. H04B 7/00

(52) U.S. Cl. 455/522

(57) ABSTRACT

Power savings in a wireless digital network. In a network having a plurality of access nodes attached to a controller, access nodes are placed in reduced power states depending on network use or time. In a first embodiment, portions of an access node may be switched between normal and low power modes based on access node activity, or on command. In a second embodiment, the entire access node may be placed in a lower power mode, and awakened from this lower power mode by a LAN signal. A power manager monitors wireless network use to determine which access nodes connected to a controller are to be placed in a low power state. Calendar and time scheduling may also be used.

### BACKGROUND OF THE INVENTION

The present invention relates to wireless systems, and in particular, to the problem of power saving in a wireless digital network.

Wireless networks, such as those operating according to IEEE 802.11 standards typically provide wireless packet-based data services to clients in a network. Such networks consist of one or more controllers which in turn feed a plurality of access nodes. In may such networks, the access nodes have wired connections to a controller.

When working properly, the access nodes which form a wireless network are an invisible part of an organization's infrastructure, providing wireless connectivity for data and voice. A large organization may have thousands of access nodes deployed over a set of buildings. While each access node on its own does not consume a large amount of power, in the aggregate, a considerable amount of power is being used.

A typical enterprise office may be occupied from 7AM to 7PM five days a week, but is vacant on weekends, holidays, and so on. During these vacant periods, wireless access nodes continue to operate at full power, with no users present

One approach to reducing such energy use is to control the operating power to access points by timers, similar to what is done with interior lighting and climate control in office buildings. But the occupants of such buildings know that those timers are set by people who live in an ideal world where work only takes place between certain hours. Engineers are accustomed to working nonstandard hours to make deadlines, accounting and finance personnel are used to working nonstandard hours to close the quarter, some people will be working weekends, and so on. There are always people who will be fighting timer-based systems. And timers are not appropriate for wireless networks; while turning off half the lighting in an office area at a certain time may only generate verbal responses from still-laboring employees, dropping power on a wireless access node could be calamitous for network transactions in process.

What is needed is a way to implement power savings in access nodes in a wireless network automatically

### BRIEF DESCRIPTION OF THE DRAWINGS

The invention may be best understood by referring to the following description and accompanying drawings that are used to illustrate embodiments of the invention in which:

FIG. 1 shows a wireless network, and

FIG. 2 shows details of an access node.

### DETAILED DESCRIPTION

Embodiments of the invention relate to methods of saving power in a wireless digital network having a controller connected to a plurality of access nodes providing wireless connectivity. In a first embodiment, portions of the access node may be selectively put into low power states. In a second embodiment, access nodes are built with a hardware wakeup such as wired Ethernet Wake on LAN circuitry so that the access node may be switched to a lower power state and reactivated over the LAN connection with the controller. The access node may sense connectivity and switch to low power states on its own. A power manager associated with the controller may sense loading on access nodes and switch access nodes to lower power states accordingly. Calendar and time awareness may be built into the power manager as well.

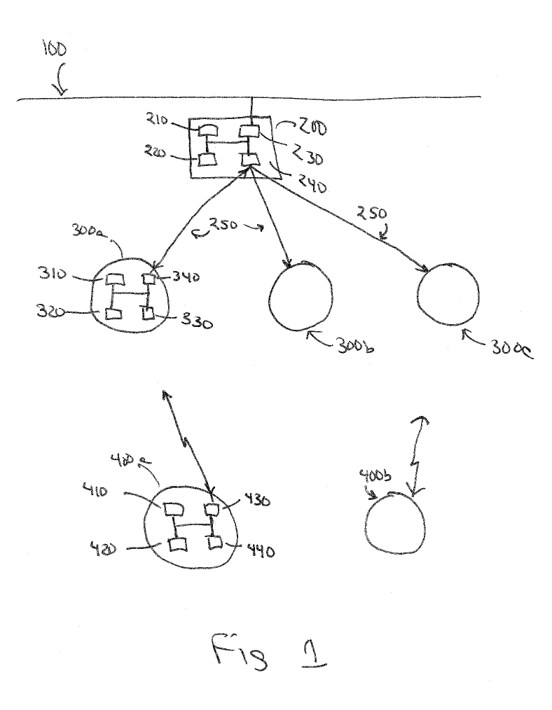

As shown in FIG. 1, a wireless digital network supports connections of wireless clients 400a, 400b to a wired network. Wired network 100, such as a wired IEEE 802.3 Ethernet network, is connected to controller 200. Controller 200 supports connections 250 to access nodes 300a, 300b, 300c. Access nodes 300a, 300b, 300c provide wireless communications to wireless clients 400a, 400b.

As is understood in the art, controller 200 is a purpose-built digital device having a CPU 210, memory hierarchy 220, and a plurality of network interfaces 230, 240. CPU 210 may be a MIPS-class processor from companies such as Raza Microelectronics or Cavium Networks, although CPUs from companies such as Intel, AMD, IBM, Freescale, or the like may also be used. Memory hierarchy 220 includes read-only memory for device startup and initialization, high-speed read-write memory such as DRAM for containing programs and data during operation, and bulk memory such as hard disk or compact flash for permanent file storage of programs and data. Network interfaces 230, 240 are typically IEEE 802.3 Ethernet interfaces to copper, although high-speed optical fiber interfaces may also be used. Controller 200 typically operates under the control of purpose-built embedded software, typically running under a Linux operating system, or an operating system for embedded devices such as VXWorks.

Similarly, as understood by the art wireless access nodes 300a, 300b and 300c are also purpose-built digital devices. These access nodes include CPUs 310, memory hierarchy 320, and wireless interfaces 330. Wireless interfaces 330 may contain one or more radio transmitter/receiver pairs. As with controller 200, the CPU commonly used for such access nodes is a MIPS-class CPU such as one from Raza Microelectronics or Cavium Networks, although processors from other vendors such as Acorn, Intel, AMD, Freescale, and IBM may be used. The memory hierarchy comprises read-only storage for device startup and initialization, fast read-write storage such as DRAM for holding operating programs and data, and permanent bulk file storage such as compact flash. Wireless access nodes 300 typically operate under control of purpose-built programs running on an embedded operating system such as Linux or VXWorks. Wireless interfaces 330 are typically interfaces operating to the family of IEEE 802.11 standards including but not limited to 802.11a, b, g, and/or n.

Interface 340, typically a wired IEEE 802.3 Ethernet interface is used to communicate 250 between access node 300a and controller 200. Interface 340 and link 250 may support Power over Ethernet (PoE), such as IEEE 802.3af, for providing operating power to access nodes 300. As understood in the art, PoE power may be supplied by controller 200, or by other switching equipment interposed between controller 200 and access nodes 300, or through a mid-span PoE injector.

Wireless client 400 is also a digital device, similarly having CPU 410, memory hierarchy 420, wireless interface 430, and I/O devices 450. As examples, wireless device 400 may be a general purpose computer such as a laptop, or may be a purpose-built device such as a Wi-Fi phone or a handheld scanner. In a general-purpose computer, CPU 410 may be a processor from companies such as Intel, AMD, Freescale, or the like. In the case of purpose-built devices, Acorn or MIPS class processors may be preferred. Memory hierarchy 420 comprises the similar set of read-only memory for device startup and initialization, fast read-write memory for device operation and holding programs and data during execution, and permanent bulk file storage using devices such as flash, compact flash, and/or hard disks. Additional I/O devices 450 may be present, such as keyboards, displays, speakers, barcode scanners, and the like.

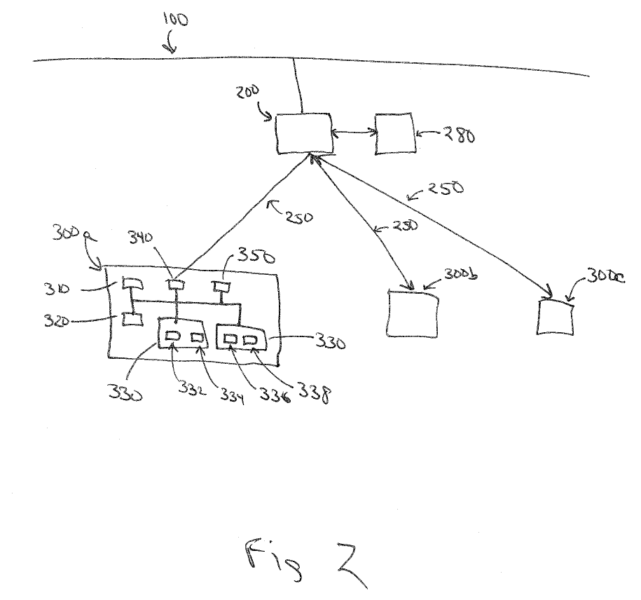

As shown in FIG. 2, access node 300 separates wireless interfaces 330 into first receiver 332 and transmitter 334, and second receiver 336 and transmitter 338, for example covering 2.4 GHz and 5 GHz WiFi channels. Also shown are wired Ethernet interfaces 340 and 350. Each subsystem also contains power switching under control of CPU 310.

In a first embodiment of the invention, access node 300 under control of software running in CPU 310 may reduce overall power consumption by reducing power used by component subsystems in response to events. These subsystems include but are not limited to radios (transmitters 334 338 and receivers 332 336), wired interfaces 340 350, and the central processing unit 310. Unused transmitters 334 or 338 may be placed in low power modes or switched off. If wired Ethernet interfaces 340 350 are present and unused, those unused interfaces may be powered off. Alternatively, those wired interfaces may be placed in a lower power mode through negotiation of a reduced link speed, for example, negotiating a Gigabit Ethernet link down to 100 megabits or even 10 megabits.

Events causing changes in the power state of access node subsystems may be internal or external. Internal events for example may include activity. Transmitters 334 338 may be powered down when not in use. If the access point does not have any connected users, it may power down receivers 332 and/or 336. Receivers 332 and/or 336 may be powered up periodically for short periods to listen for traffic. When traffic is detected by a powered up receiver 332 or 336, such as probe request frames from a wireless client, or data is received from the Ethernet port 340 connecting access node 300 to controller 200, subsystems are returned to higher power states as required.

According to an aspect of the invention, wired Ethernet interfaces 340 350 may support the generation of hardware interrupts when incoming activity is detected. This capability is known to the art as Wake on LAN. Using this capability, access node may place as much of the access node as possible into low power modes, waiting for an interrupt from the wired Ethernet port to bring access node subsystems to higher power states as needed.

According to an aspect of the invention, steps may be taken in the software running in CPU 310 to reduce its power consumption. In many architectures, it is common to use device polling loops or status loops, for example starting an operation and then entering a tight loop loading status, testing for complete, and if not, branching back to the step of loading status. Such techniques are simple to design and code, but insure the processor is running continuously. Many processors support low power halt or wait states, entered by executing a particular instruction. A well known software technique is to replace polling and/or status loops with interrupt-driven operation and wait loops. In such a system, extensive use of interrupts is made, and when the software is waiting for an event to occur, such as a frame received by a receiver, if the processor does not have other computation to perform, such as lower-priority tasks, it enters a wait state, waiting for an interrupt to occur and initiate the required processing.

According to an aspect of the invention, an individual access node 300 may combine many of these approaches in saving power. As an example, if the access node is idle, it may power down transmitters and receivers 332 334 336 338, enable Wake on LAN interrupts from Ethernet ports 340 and/or 350, and then place the processor in a low power wait state, waiting for a Wake on LAN interrupt to wake the access node and resume operation by restoring subsystems to normal operation as required.

While a single access node 300 may control power to its subsystems, switching them to low power modes when full functionality is not needed, this process may be managed effectively over a set of access nodes 300 connected to controller 200, and managed by power manager 280. Power manager 280 may be a process running on the same hardware as controller 200, or it may be a separate computer running the power management software, and communicating with controller 200 as shown in FIG. 2. If present as a separate computer, power manager 280 has the same general structure as the other digital devices in the system; a CPU, memory hierarchy including mass storage, communication links, and possibly other input/output devices such as displays, keyboards, and mice.

According to an aspect of the invention, power manager 280 monitors access nodes 300a, 300b, 300c connected to controller 200, and possibly similar access nodes connected to controllers on network 100. Assume for example that access nodes 300a, 300b, and 300c are located in a common area to serve normal and peak wireless networking requirements of clients in that area. By monitoring network usage, power manager 280 may for example recognize when access nodes 300a and 300b are not being used and command them into power saving states. If clients are still connected to access node 300c, process 280 may command the transmitters in access node 300c to a higher power level to better serve those clients. Power manager 280 may use access node 300c to monitor for activity in the area served, commanding access points 300a and/or 300b back to full operation when needed.

If some access nodes are powered through PoE connections which may be controlled by power manager 280, PoE power may be switched off to access nodes when they are idle. Cycling power in this manner, using PoE control, while offering the highest power savings, will most likely also represent the longest recovery time for access nodes. While an access node that has been operating in a low-power wait state, or has powered down its transmitters and receivers may return to full operation in a matter of milliseconds, switching access node power via PoE in essence reboots the access node, causing it to go through its initialization process, which may take many seconds. This delay may be significantly reduced through use of a capability commonly known to the art as software hibernation, which essentially entails saving a snapshot of the device to non-volatile memory before the device is powered off, and then restoring device operation from the snapshot rather than going through the entire initialization process.

According to another aspect of the invention, power manager 280 may keep a representation of the state of the access nodes it is monitoring. This representation may include power status, such as normal operation, low power, powered off, or the like. This representation may be updated by messages from access nodes 300, by messages from controller 200, or by power manager 280 for example as it sends messages to access nodes 300.

While power manager 280 may be driven by calendar or clock events, such as recognizing holidays, weekends, and nominal office hours, it is likely that more power savings can be achieved by allowing power manager 280 to monitor network activity in controllers 200 and their attached access nodes 300 and adjust their operation accordingly, operating access nodes at full power levels as needed to meet client demand.

While the invention has been described in terms of various embodiments, the invention should not be limited to only those embodiments described, but can be practiced with modification and alteration within the spirit and scope of the appended claims. The description is this to be regarded as illustrative rather than limiting.

What is claimed is:

1. In a digital network comprising at least one controller to which one or more access nodes are connected through a first interface in the access node connecting the access node to the controller, the access nodes providing wireless connectivity to wireless clients through one or more radios, each radio having a transmitter and a receiver, a method of operating an access node comprising:
sensing an event, and
responding to the event by changing a subsystem in the access node from normal operation to low power operation, or from low power operation to normal operation.

2. The method of claim 1 where the event is generated internally to the access node.

3. The method of claim 1 where the event is generated externally to the access node.

4. The method of claim 2 where the event is detecting that no wireless clients are connected to the access node and the response to the event is changing one or more access node subsystems to low power operation.

5. The method of claim 2 where the event is detecting activity on a receiver in the access node and the response to the event is changing one or more access node subsystems to normal operation.

6. The method of claim 3 where the event is a message received at the first interface of the access node.

7. The method of claim 3 where the first interface is a wired Ethernet interface.

8. The method of claim 1 further including a power manager monitoring activity in a plurality of access nodes connected to a controller.

9. The method of claim 8 where the power manager maintains a representation of at least part of the state of the access nodes it monitors.

10. The method of claim 8 where the power manager resides in the controller.

11. The method of claim 8 where the power manager resides in a system connected to at least one controller.

12. The method of claim 8 where the power manager generates events to one or more access nodes.

13. The method of claim 12 where the power manager generates events to one or more access nodes causing at least one subsystem in each of the one or more access nodes to change to low power operation.

14. The method of claim 13 where the power manager generates events to one or more access nodes causing at least one subsystem in each of the one or more access nodes to change to normal operation.

15. The method of claim 12 where the power manager generates events to one or more access nodes based on monitored activity on the one or more access nodes.

16. The method of claim 12 where the power manager generates events to one or more access nodes based on the time and/or date.
